(19) United States
(12) Patent Application Publication
(10) Pub. No.: US 2025/0335632 A1
(43) Pub. Date: Oct. 30, 2025

(54) IMAGE PROCESSING APPARATUS

(71) Applicant: KYOCERA Document Solutions Inc., Osaka (JP)

(72) Inventors: Ryota OKUI, Osaka (JP); Hiroshi SUGIHARA, Osaka (JP); Koji SATO, Osaka (JP); Kota KAMISONO, Osaka (JP)

(73) Assignee: KYOCERA Document Solutions Inc., Osaka (JP)

(21) Appl. No.: 19/185,361

(22) Filed: Apr. 22, 2025

(30) Foreign Application Priority Data
Apr. 24, 2024 (JP) 2024-070617

(51) Int. Cl. G06F 21/62; G06V 10/25; G06V 30/10

(52) U.S. Cl. CPC G06F 21/6254; G06V 10/25; G06V 30/10

(57) ABSTRACT

An image processing apparatus includes an image reading portion and a control portion that performs an anonymizing process on original image data to generate output image data in which personal information is anonymized. When generating the output image data, the control portion extracts text data by an OCR process on the original image data, extracts from the text data a personal name as personal information, recognizes as a target region a region of the original image data that contains the personal name, and performs a process of making unrecognizable any character other than an initial character in a character string constituting the personal name in the target region.

### INCORPORATION BY REFERENCE

This application is based on and claims the benefit of priority from Japanese Patent Application No. 2024-070617 filed on Apr. 24, 2024, the contents of which are hereby incorporated by reference.

### BACKGROUND

The present disclosure relates to image processing apparatuses.

Some known image processing apparatuses read documents containing personal information and perform an anonymizing process (in other words, concealing process) on a region corresponding to the personal information in the image data acquired by reading the documents.

### SUMMARY

According to ne aspect of the present disclosure, an image processing apparatus includes an image reading portion and a control portion. The image reading portion reads a document containing personal information. The control portion performs an anonymizing process on original image data acquired through the reading of the document by the image reading portion and thereby generates output image data in which the personal information is anonymized. When generating the output image data, the control portion extracts text data by an OCR process on the original image data, extracts from the text data a personal name as the personal information, recognizes as a target region a region of the original image data that contains the personal name, and performs as the anonymizing process a process of making unrecognizable any character other than an initial character in a character string constituting the personal name in the target region.

### BRIEF DESCRIPTION OF THE DRAWINGS

FIG. 1 is a schematic diagram of a multifunction peripheral according to one embodiment.

FIG. 2 is a block diagram of the multifunction peripheral according to the embodiment.

FIG. 3 is a diagram schematically showing one example of a document (personal information) that can be the target of reading on the multifunction peripheral according to the embodiment.

FIG. 4 is a flow chart showing a procedure for an anonymizing job performed on the multifunction peripheral according to the embodiment.

FIG. 5 is a diagram in illustration of a first process as the anonymizing process performed on the multifunction peripheral according to the embodiment.

FIG. 6 is a diagram in illustration of a second process as the anonymizing process performed on the multifunction peripheral according to the embodiment.

FIG. 7 is a diagram in illustration of a third process as the anonymizing process performed on the multifunction peripheral according to the embodiment.

### DETAILED DESCRIPTION

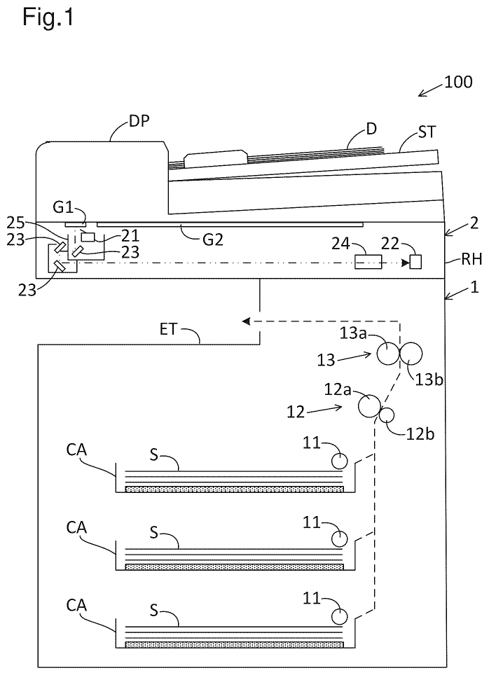

Configuration of a Multifunction Peripheral: With reference to FIGS. 1 to 7, an image processing apparatus according to one embodiment of the present disclosure will be described below taking as an example a multifunction peripheral 100 having a plurality of functions such as scanning, printing, and data transmission.

As shown in FIG. 1, the multifunction peripheral 100 (corresponding to an “image processing apparatus”) includes a printing portion 1. The printing portion 1 constitutes the body of the multifunction peripheral 100. The printing portion 1 prints an image on a sheet S. The printing portion 1 employs an electrophotographic printing process. This however is not meant as any limitation: the printing portion 1 can employ an inkjet printing process.

The printing portion 1 forms an image based on image data fed to the multifunction peripheral 100. The printing portion 1 conveys the sheet S along a sheet conveyance passage. The printing portion 1 prints an image on the sheet S being conveyed. In FIG. 1, the sheet conveyance passage is indicated by a broken line.

The printing portion 1 includes a sheet feed roller 11. The sheet feed roller 11 lies in contact with the sheet S stored in a sheet cassette CA and rotates in that state. Thus the sheet feed roller 11 feeds the sheet S from the sheet cassette CA to the sheet conveyance passage.

The printing portion 1 includes an image forming portion 12. The image forming portion 12 includes a photosensitive drum 12a and a transfer roller 12b. The photosensitive drum 12a carries a toner image on its circumferential surface. The transfer roller 12b stays in pressed contact with the photosensitive drum 12a and forms a transfer nip with the photosensitive drum 12a. The transfer roller 12b rotates together with photosensitive drum 12a. The image forming portion 12, while conveying the sheet S having entered the transfer nip, transfers the toner image to the sheet S.

The image forming portion 12 further includes, though not shown, a charging device, an exposure device, and a developing device. The charging device electrostatically charges the circumferential surface of the photosensitive drum 12a. The exposure device forms an electrostatic latent image on the circumferential surface of the photosensitive drum 12a. The developing device develops the electrostatic latent image on the circumferential surface of photosensitive drum 12a into a toner image.

The printing portion 1 includes a fixing portion 13. The fixing portion 13 includes a heating roller 13a and a pressing roller 13b. The heating roller 13a incorporates a heater (not shown). The pressing roller 13b stays in pressed contact with the heating roller 13a to form a fixing nip with the heating roller 13a. The pressing roller 13b rotates together with the heating roller 13a. The fixing portion 13, while conveying the sheet S having entered the fixing nip, fixes the toner image transferred to the sheet S to the sheet S. The sheet S having left the fixing nip is discharged to a discharge tray ET.

The multifunction peripheral 100 also includes an image reading portion 2. The image reading portion 2 is disposed over the body of the multifunction peripheral 100. In a job involving the reading of a document D, the document D is set on the image reading portion 2. The image reading portion 2 reads the document D set on the image reading portion 2 to generate the image data of the read document D.

The image reading portion 2 includes contact glasses G1 and G2. The contact glasses G1 and G2 are arranged in a housing RH of the image reading portion 2. The housing RH has an opening in its top face. The contact glasses G1 and G2 are fitted in the opening in the top face of the housing RH.

The image reading portion 2 includes a document conveying device DP. The document conveying device DP is fitted to the housing RH. As seen from in front of the multifunction peripheral 100, the document conveying device DP pivots such that a front part of it swings up and down about a rear part of it. The document conveying device DP thus opens and closes with respect to the top face of the housing RH.

The document conveying device DP has a set tray ST on which the document D is set. The document conveying device DP conveys the document D set on the set tray ST onto the contact glass G1.

In a feed-reading mode, the user sets the document D on the set tray ST. The document D automatically conveyed onto the contact glass G1 by the document conveying device DP (in other words, the document D passing over the contact glass G1) is read. On the other hand, in a stationary reading mode, the user sets the document D on the contact glass G2, and the document D on the contact glass G2 is read.

The image reading portion 2 includes a light source 21, an image sensor 22, a mirror 23, and a lens 24. The light source 21, the image sensor 22, the mirror 23, and the lens 24 are arranged inside the housing RH. The image reading portion 2 carries out scanning operation by emitting light from the light source 21 to the contact glass G1 or G2 and performing photoelectric conversion in the image sensor 22.

The light source 21 has a plurality of LED elements. The plurality of LED elements are arrayed in a line along the main scanning direction (the direction perpendicular to the plane of FIG. 1). The image sensor 22 has a plurality of photoelectric conversion elements lined up along the main scanning direction. The mirror 23 reflects light toward the lens 24. The lens 24 collects the light reflected from the mirror 23 and directs it to the image sensor 22.

The light source 21 and the mirror 23 are arranged on a carriage 25 that is movable in the sub (subsidiary) scanning direction (the left-right direction in FIG. 1), which is orthogonal to the main scanning direction. As the carriage 25 moves in the sub scanning direction, the reading line of the image reading portion 2 moves in the sub scanning direction.

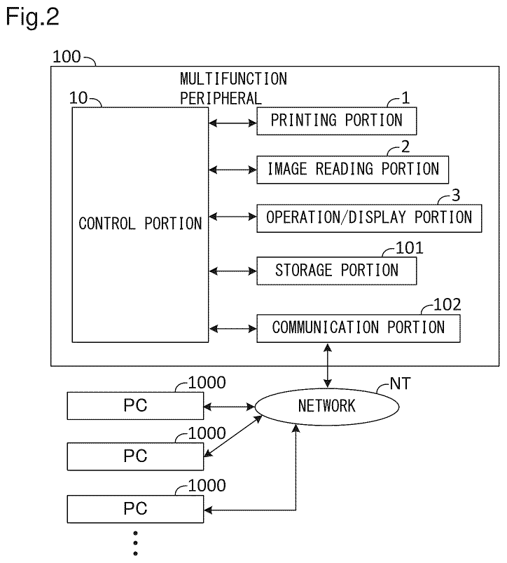

As shown in FIG. 2, the multifunction peripheral 100 includes an operation/display portion 3. The operation/display portion 3 is an operation panel with a touch screen. The operation/display portion 3 displays software buttons, messages, and the like on the touch screen. The operation/display portion 3 also has a plurality of hardware buttons. The operation/display portion 3 accepts operations from the user. Via the operation/display portion 3 the user can make settings for various jobs including an anonymizing job, which will be described later.

The multifunction peripheral 100 includes a control portion 10. The control portion 10 includes a CPU, an ASIC, a memory, and the like. The control portion 10 also includes an image processing circuit. The control portion 10 performs various kinds of image processing on image data. The control portion 10 also controls the printing of an image on the sheet S by the printing portion 1, and controls the reading of the document D by the image reading portion 2.

The control portion 10 also controls the operation/display portion 3. Specifically, the control portion 10 controls display operation on the touch screen. The control portion 10 senses operations on the software buttons and the hardware buttons. Based on the operations that the operation/display portion 3 accepts from the user, the control portion 10 makes settings for a job.

The multifunction peripheral 100 includes a storage portion 101. The storage portion 101 is a non-volatile storage device. U sable as the storage portion 101 is an HDD or an SSD. The storage portion 101 is connected to the control portion 10. The control portion 10 writes information to and reads information from the storage portion 101.

The storage portion 101 previously stores a character recognition program. Based on the character recognition program, the control portion 10 performs a character recognition process such as OCR (optical character recognition). The control portion 10 handles as the target of the character recognition process the image data acquired through the reading of the document D by the image reading portion 2.

The multifunction peripheral 100 includes a communication portion 102. The communication portion 102 is an interface that permits an external device to be connected to the multifunction peripheral 100 so that communication is possible between them. The communication portion 102 includes a communication circuit, a communication memory, a communication connector, and the like. The communication portion 102 is connected to the control portion 10. Using the communication portion 102 the control portion 10 exchanges data with the external device.

The communication portion 102 is connected to the external device across a network NT such as a LAN and the Internet so that communication is possible between them. Though not illustrated, the communication portion 102 can be connected directly to the external device via a communication cable. The external device connected to the communication portion 102 is, for example, a personal computer 1000 (hereinafter “PC 1000”) used by the user of the multifunction peripheral 100. Any external device other than the PC 1000 can be connected to the multifunction peripheral 100 so that communication is possible between them. Connecting the PC 1000 to the multifunction peripheral 100 permits the image data of the document D acquired through the reading of the document D by the image reading portion 2 to be transmitted to the PC 1000. Thus, the image data of the document D can be stored on the PC 1000.

Outline of the Anonymizing Process: The multifunction peripheral 100 has an anonymizing function. In other words, the multifunction peripheral 100 can perform a job related to the anonymizing function (hereinafter “anonymizing job”). In the anonymizing job, a document D containing personal information is read and the image data acquired by reading the document D, that is, original image data, is subjected to an anonymizing process to anonymize the personal information. Thus, output image data is generated in which at least part of the personal information is anonymized. The output image data is image data generated from the original image data, and is image data in which part of the original image data is modified.

Using the anonymizing function permits one to acquire image data (i.e., output image data) resulting from anonymizing at least part of personal information contained in a document D. One can then print on a sheet S an image based on the output image data. One can also transmit the output image data to the PC 1000 to store it on the PC 1000.

A document D containing personal information can be, among many other, a driving license, health insurance card, passport, or medical record (clinical record). Personal information can be, among many other, a personal name, address, telephone number, credit card number, or mail address. In the following description, a document D containing personal information is termed simply as “document D.”

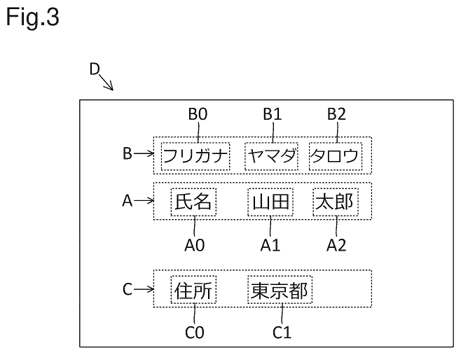

FIG. 3 schematically shows one example of a document D. The document D contains personal information particulars (values of items) and personal information types (names of items) in pairs. For convenience' sake, FIG. 3 shows as personal information particulars a personal name (accompanied by a phonetic transcription called “furigana”) and an address. The document D shown in FIG. 3 contains personal information in Japanese.

To perform an anonymizing job, the user sets a document D in the image reading portion 2. In this state the user performs on the operation/display portion 3 a starting operation for the anonymizing job. When the starting operation is performed on the operation/display portion 3, the control portion 10 starts the anonymizing job.

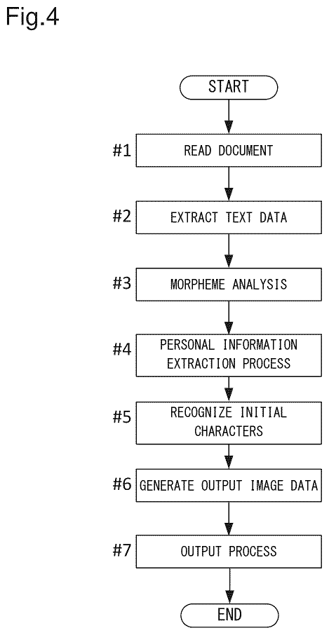

Now, with reference to the flow chart in FIG. 4 the procedure for the anonymizing job will be described. The procedure shown in FIG. 4 starts when the starting operation for the anonymizing job is performed on the operation/display portion 3.

At step #1, the control portion 10 makes the image reading portion 2 read the document D. The image reading portion 2 reads the document D and generates the image data of the read document D. The image data generated here is original image data. The control portion 10 acquires the original image data obtained through the reading of the document D by the image reading portion 2.

At Step #2, the control portion 10 performs an OCR process on the original image data to extract text data from the original image data. Thus the control portion 10 recognizes character strings in the original image data. The control portion 10 also recognizes the positions (i.e., coordinates) of character regions containing the character strings in the original image data. If the document D shown in FIG. 3 is the target of the anonymizing job, character strings A, B, and C are extracted as text data.

At Step #3, the control portion 10 performs morpheme analysis on the text data extracted from the original image data. That is, the control portion 10 segmentizes the text data extracted from the original image data in units of words. If the document D shown in FIG. 3 is the target of the anonymizing job, character string A is segmentized into character strings A0, A1, and A2, each as a word; character string B is segmentized into character strings B0, B1, and B2, each as a word; character string C is segmentized into character strings C0 and C1, each as a word. Moreover, by performing morpheme analysis on the text data extracted from the original image data, the control portion 10 discriminates the part-of-speech of each word (i.e., segmentized character string) in the text data.

At Step #4, the control portion 10 performs a personal information extraction process. Specifically, for each word in the text data extracted from the original image data, the control portion 10 checks whether it is personal information to extract personal information from the text data. In other words, the control portion 10 extract proper nouns from the text data.

The personal information extraction process employs a machine learning model for proper noun extraction. A machine learning model for the personal information extraction process is a trained proper noun extraction model and is previously stored in the storage portion 101. Using the machine learning model the control portion 10 extracts character strings that are supposed to be personal information. Through the personal information extraction process the control portion 10 extracts, from the text data corresponding to the original image data, a personal name (a surname and a given name)

If the document D shown in FIG. 3 is the target of the anonymizing job, character strings A1, A2, B1, B2, and C1 are proper nouns, and thus character strings A1, A2, B1, B2, and C1 are extracted as personal information. Character strings A1 and B1 are discriminated as a surname in a personal name and character strings A2 and B2 are recognized as a given name in a personal name.

At Step #5, the control portion 10 recognizes the initial characters of the personal name as personal information. If the surname and the given name are separated from each other with a space, the control portion 10 recognizes the initial characters of both the surname and the given name. That is, the control portion 10 discriminates a delimiter in a character string constituting a personal name and recognizes the first character of each of the plurality of character strings separated by the delimiter as an initial character.

If the document D shown in FIG. 3 is the target of the anonymizing job, the first character of character string A1 and the first character of character string A2 are each recognized as an initial character in a personal name. Likewise, the first character of character string B1 and the first character of character string B2 are each recognized as an initial character in a personal name.

At Step #6, the control portion 10 performs an anonymizing process on the original image data. By so doing the control portion 10 generates output image data in which personal information (specifically, a personal name) is anonymized. The anonymizing process is a process whereby personal information in a target region is anonymized.

When generating the output image data, the control portion 10 recognizes as the target region a region in the original image data that contains a personal name as personal information. That is, the control portion 10 recognizes as the target region a region that contains a personal name to be anonymized.

After recognizing the target region in the original image data, the control portion 10 anonymizes the personal name as personal information in the target region. Specifically, the control portion 10 performs as the anonymizing process a process of making unrecognizable the characters other than the initial characters in the character strings constituting the personal name in the target region.

At Step #7, the control portion 10 makes an output portion perform an output process for the output image data. For example, various settings for the anonymizing job include selection of the mode of output of the output image data. Different modes include printing and transmission.

If printing is selected as the mode of output, the control portion 10 makes the printing portion 1 print (in other words, output) an image based on the output image data on a sheet S. In this case, the printing portion 1 corresponds to the “output portion” and the output destination is the sheet S.

If transmission is selected as the mode of output, the control portion 10 makes the communication portion 102 transmit (in other words, output) the output image data to the PC 1000. The output image data can be converted into PDF data before being transmitted to the PC 1000. Transmitting the output image data to the PC 1000 permits the output image data to be stored on the PC 1000. In this case, the communication portion 102 corresponds to the “output portion” and the output destination is the PC 1000.

Anonymizing Personal Information: The anonymizing process on a personal name as personal information can be a first, a second, or a third process.

For example, the control portion 10 recognizes the composition of a character string in the target region. Specifically, the control portion 10 recognizes whether a character string in the target region is a Japanese character string or an alphabetic character string (e.g., Latin character string). If a character string in the target region is a Japanese character string, the control portion 10 then recognizes whether it contains a Chinese character accompanied by a phonetic transcription (furigana). Then according to the composition of the character string in the target region, the control portion 10 performs one of the first, second, and third processes as the anonymizing process.

Or, the control portion 10 can perform as the anonymizing process, for example, the one selected by the user from the first, second, and third processes. With this configuration, the operation/display portion 3 accepts from the user an operation to select one of the first, second, and third processes.

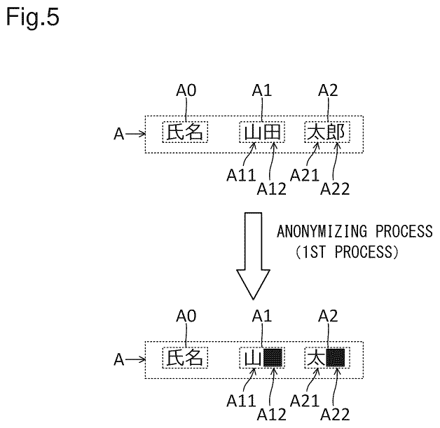

1. First Process: The first process will be described with reference to FIG. 5.

If a personal name in the target region is composed of a Japanese character string, the control portion 10 performs as the first process (anonymizing process) a process of blacking out (or otherwise obscuring) the characters other than the initial characters in the Japanese character string constituting the personal name in the target region.

In the example shown in FIG. 5, the first character A11 of character string A1 is recognized as an initial character and the first character A21 of character string A2 is recognized as an initial character. Thus the second character A12 of character string A1 is blacked out and the second character A22 of character string A2 is blacked out. In FIG. 5, the target region before the anonymizing process (i.e., the original image data) is shown at top and the target region after the anonymizing process (i.e., the output image data) is shown at bottom.

Here, in the example shown in FIG. 5, character strings A1 and A2 are separated by a space. Accordingly, not only character A 11 in character string A1 but also character A21 in character string A2 are recognized as initial characters. If, however, character strings A1 and A2 are not separated, only character A11 is recognized as an initial character. In this case, character A12 in character string A1 is blacked out and in addition both characters A21 and A22 in character string A2 are blacked out.

The target of the first process is not limited to a Japanese character string composed solely of Chinese characters. Though not illustrated, the first process can be performed on a Japanese character string composed solely of “hiragana” characters, or the anonymizing process can be performed on a Japanese character string composed solely of “katakana” characters. Or, the first process can be performed on a Japanese character string containing two or more types of characters out of hiragana, katakana, and Chinese.

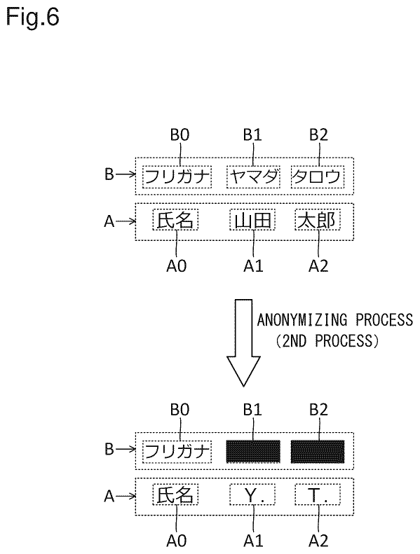

2. Second Process: The second process will be described with reference to FIG. 6.

If a personal name in the target region is composed of a Japanese character string containing a Chinese character, the control portion 10 checks whether the Chinese character is accompanied by a phonetic transcription (furigana). If the Chinese character is accompanied by a phonetic transcription, based on the phonetic transcription the control portion 10 recognizes an alphabetic character string obtained by Romanizing the Japanese character string constituting the personal name in the target region

For example, a Romanization table for Romanizing Japanese (specifically, hiragana and katakana characters) is previously stored in the storage portion 101. Based on the Romanization table the control portion 10 Romanizes the Japanese character string constituting the personal name in the target region. That is, based on Romanization table the control portion 10 transliterates into an alphabetic character string the Japanese character string constituting the personal name in the target region. The control portion 10 then performs as the second process (anonymizing process) a process of replacing the Japanese character string constituting the personal name in the target region with a character string composed of the initial characters in that alphabetic character string.

In the example shown in FIG. 6, character strings A1 and A2 correspond to a personal name and thus the personal name is in Chinese characters. Character string B1 corresponds to the phonetic transcription accompanying character string A1 and character string B2 corresponds to the phonetic transcription accompanying character string A2. That is, in the example shown in FIG. 6, the personal name in the target region is composed of Chinese characters accompanied by a phonetic transcription.

In the example shown in FIG. 6, Romanizing the Japanese character string constituting the personal name yields “YAMADA TARO”; thus, as the character string composed of the initial characters in it, “YT” is generated. As a result, the Japanese character string constituting the personal name is replaced with the character string “YT.” For example, in the second process, each character in the character string after replacement can be suffixed with a period to indicate abbreviation.

In the second process, a character string constituting a phonetic transcription (in the example shown in FIG. 6, character strings B1 and B2) is made unrecognizable. As shown at bottom in FIG. 6, a character string constituting a phonetic transcription can be blacked out. Or, though not illustrated, a character string constituting a phonetic transcription can be erased.

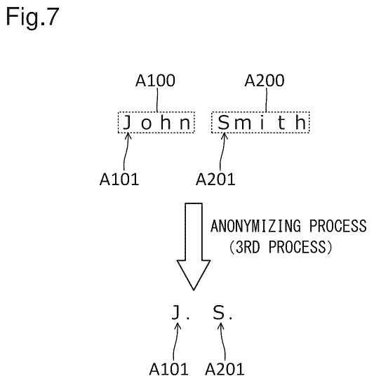

3. Third Process: The third process will be described with reference to FIG. 7.

If a personal name in the target region is composed of an alphabetic character string, the control portion 10 performs as the third process (anonymizing process) a process of replacing the alphabetic character string constituting the personal name in the target region with a character string composed of the initial characters in that alphabetic character string.

In the example shown in FIG. 7, the first character A101 in character string A 100 is recognized as an initial character and the first character A 201 in character string A200 is recognized as an initial character. Thus, a character string composed of characters A101 and A201, “JS,” is generated. Then the alphabetic character string constituting the personal name is replaced with the character string “JS.” For example, in the third process, each character in the character string after replacement can be suffixed with a period to indicate abbreviation.

In the embodiment, a process of making unrecognizable any character other than an initial character in a character string constituting a personal name (i.e., personal information) in original image data acquired by reading a document D is performed as an anonymizing process. With this configuration, initial characters in a personal name are recognizable and thus an insider can easily guess whom the output image data (i.e., the image data after the anonymizing process) corresponds to. On the other hand, even if the output image data is acquired by a third party, the personal information is saved from being divulged to the third party. It is thus possible to protect personal information securely from a third party and to enhance the convenience of using the output image data.

According to the embodiment, in cases where a personal name as personal information is composed of a Japanese character string, by performing the first process, it is easily possible to protect personal information securely from a third party and to enhance the convenience of using the output image data.

According to the embodiment, in cases where a personal name as personal information is composed of a Japanese character string that contains a Chinese character accompanied by a phonetic transcription, by performing the second process, it is easily possible to protect personal information securely from a third party and to enhance the convenience of using the output image data.

According to the embodiment, in cases where a personal name as personal information is composed of an alphabetic character string, by performing the third process, it is easily possible to protect personal information securely from a third party and to enhance the convenience of using the output image data.

According to the embodiment, the first character in each of a plurality of character strings separated from each other with a delimiter (specifically, space) is recognized as an initial character. That is, after the anonymizing process, a personal name as personal information is indicated by the initial character of the surname and the initial character of the given name. This permits an insider to identify the personal information easily and hence with enhanced convenience.

The embodiment disclosed herein should be understood to be in every aspect illustrative and not restrictive. The scope of the present disclosure is defined not by the description of the embodiment given above but by the appended claims and encompasses any modifications made within a scope equivalent in significance to those claims.

What is claimed is:

1. An image processing apparatus comprising:
an image reading portion that reads a document containing personal information; and
a control portion that performs an anonymizing process on original image data acquired through reading of the document by the image reading portion, the control portion thereby generating output image data in which the personal information is anonymized,
wherein
when generating the output image data, the control portion
extracts text data by an OCR process on the original image data,
extracts from the text data a personal name as the personal information,
recognizes as a target region a region of the original image data that contains the personal name, and
performs as the anonymizing process a process of making unrecognizable any character other than an initial character in a character string constituting the personal name in the target region.

2. The image processing apparatus according to claim 1, wherein
if the personal name in the target region is composed of a Japanese character string, the control portion performs as the anonymizing process a process of blacking out any character other than an initial character in the Japanese character string constituting the personal name in the target region.

3. The image processing apparatus according to claim 1, wherein
if the personal name in the target region is composed of a Japanese character string containing a Chinese character, the control portion checks whether the Chinese character is accompanied by a phonetic transcription, and
if the Chinese character is accompanied by a phonetic transcription, based on the phonetic transcription the control portion recognizes an alphabetic character string obtained by Romanizing the Japanese character string constituting the personal name in the target region, and
the control portion performs as the anonymizing process a process of replacing the Japanese character string constituting the personal name in the target region with a character string composed of an initial character in the alphabetic character string.

4. The image processing apparatus according to claim 1, wherein
if the personal name in the target region is composed of an alphabetic character string, the control portion performs as the anonymizing process a process of replacing the alphabetic character string constituting the personal name in the target region with a character string composed of an initial character in the alphabetic character string.

5. The image processing apparatus according to claim 1, wherein
the control portion discriminates a delimiter in the character string constituting the personal name and recognizes as an initial character a first character of each of a plurality of character strings separated by the delimiter.

6. The image processing apparatus according to claim 1, further comprising:
an output portion that performs an output process for the output image data,
wherein
the output portion is at least either
a printing portion that, as the output process, prints an image based on the output image data on a sheet and
a communication portion that, as the output process, transmits the output image data to an external device.
